(19) United States
(12) Patent Application Publication
(10) Pub. No.: US 2019/0291502 A1
(43) Pub. Date: Sep. 26, 2019

(54) FORMING A NON-PLANAR COMPOSITE

(71) Applicant: Microsoft Technology Licensing, LLC, Redmond, WA (US)

(72) Inventor: David Paul PLATT, North Bend, WA (US)

(73) Assignee: Microsoft Technology Licensing, LLC, Redmond, WA (US)

(21) Appl. No.: 15/926,963

(22) Filed: Mar. 20, 2018

(51) Int. Cl. B44C 1/10; B44C 3/08; B21D 24/10; B32B 27/36; B32B 15/18

(52) U.S. Cl. CPC B44C 1/105; B44C 3/087; B21D 24/10; B32B 27/365; B32B 2262/103; B32B 2250/40; B32B 2255/26; B32B 2311/24; B32B 2307/204; B32B 15/18

(57) ABSTRACT

Examples are disclosed that relate to composites and methods for forming non-planar composites. In one example, a method comprises: providing a first non-planar metallic skin and a second non-planar metallic skin, providing a substantially planar polymer core between the first non-planar metallic skin and the second non-planar metallic skin, and using the first non-planar metallic skin and the second non-planar metallic skin (1) to deform the core between the first non-planar metallic skin and the second non-planar metallic skin and (2) to bond the core to one or more of the first non-planar metallic skin and the second non-planar metallic skin.

### BACKGROUND

One way to lighten structures with little impact to stiffness and strength is to create a composite with thin metal walls and a light polymer core in between. Thin-walled composite formed enclosures may be used for automobile and aircraft parts, computing devices, and many other lightweight products. Strong and lightweight planar enclosures may be formed using laminated composite materials. However, some laminated composite materials cannot be deformed into non-planar three-dimensional forms.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to composites and methods for forming non-planar composites. In one example, a method comprises providing a first non-planar metallic skin and a second non-planar metallic skin, providing a substantially planar core between the first non-planar metallic skin and the second non-planar metallic skin, and using the first non-planar metallic skin and the second non-planar metallic skin (1) to deform the core between the first non-planar metallic skin and the second non-planar metallic skin and (2) to bond the core to one or more of the first non-planar metallic skin and the second non-planar metallic skin.

### BRIEF DESCRIPTION OF THE DRAWINGS

FIG. 1 is an illustrative example of a U-shaped first non-planar metallic skin, a second U-shaped non-planar metallic skin, and a substantially planar core according to examples of the present disclosure.

FIG. 2 is an illustrative example of a first four-sided bucket-shaped non-planar metallic skin, a second four-sided bucket-shaped non-planar metallic skin, and a substantially planar core according to examples of the present disclosure.

FIG. 3 schematically illustrates a cross-section view of the first non-planar metallic skin and the second non-planar metallic skin of FIG. 1.

FIG. 4 schematically illustrates examples of a rib and an interface in a non-planar metallic skin according to examples of the present disclosure.

FIG. 5 schematically illustrates a first non-planar metallic skin over a punch, a second non-planar metallic skin in a die, and a substantially planar core according to examples of the present disclosure.

FIG. 6 schematically illustrates using the first non-planar metallic skin over the punch and the second non-planar metallic skin in the die to deform the core according to examples of the present disclosure.

FIG. 7A is an illustrative example of an adhesive applied to a first non-planar metallic skin according to examples of the present disclosure.

FIG. 7B schematically illustrates a cross-section view of a bonded laminate composite formed using the skins and adhesive of FIG. 7A according to examples of the present disclosure.

FIG. 8A is an illustrative example of an adhesive applied to a core according to examples of the present disclosure.

FIG. 8B schematically illustrates a cross-section view of a bonded laminate composite formed using the skins and adhesive of FIG. 8A according to examples of the present disclosure.

FIG. 9 schematically illustrates a cross-section view of a non-planar composite that is formed according to examples of the present disclosure.

FIG. 10 schematically illustrates a perspective view of a four-sided bucket-shaped non-planar composite that is formed according to examples of the present disclosure.

FIGS. 11A and 11B are a block diagram of a method for forming a non-planar composite according to examples of the present disclosure.

### DETAILED DESCRIPTION

A variety of products and components utilize enclosures that are desirably strong and stiff while also being lightweight. Examples include, but are not limited to, computing devices, parts for automobiles, aircraft, spacecraft, and the like. In some examples, such enclosures may have complex, three-dimensional shapes that create challenges in achieving the desired material properties while also being lightweight and enabling acceptable manufacturability.

In some structures, an outer surface of the structure may provide most of the stiffness and strength of the structure, while the core of the structure may primarily add weight and contribute less to the strength and stiffness. Lighter structures may be formed by removing portions of the solid material core. However, such processes can be labor-intensive and ill-suited for high volume, low cost manufacturing.

For example, hollow structural members take advantage of the strength and stiffness of the outer surface of the structure while a hollow core reduces weight. However, once manufactured hollow structural members generally cannot be formed into non-planar shapes, such as by thermoforming.

In other examples, a core of a lightweight material and strong outer skins may be laminated into a planar composite. For example, two flat metal sheets may be laminated to a polymer core to form a laminated planar composite sheet. However, such planar laminated composites lack sufficient structural integrity to allow the composite to be formed into complex shapes, such as non-planar three-dimensional forms. For example, thermoforming the laminated composite sheet described above may cause the polymer core to collapse, squeezing the polymer out of the perimeter of the composite sheet.

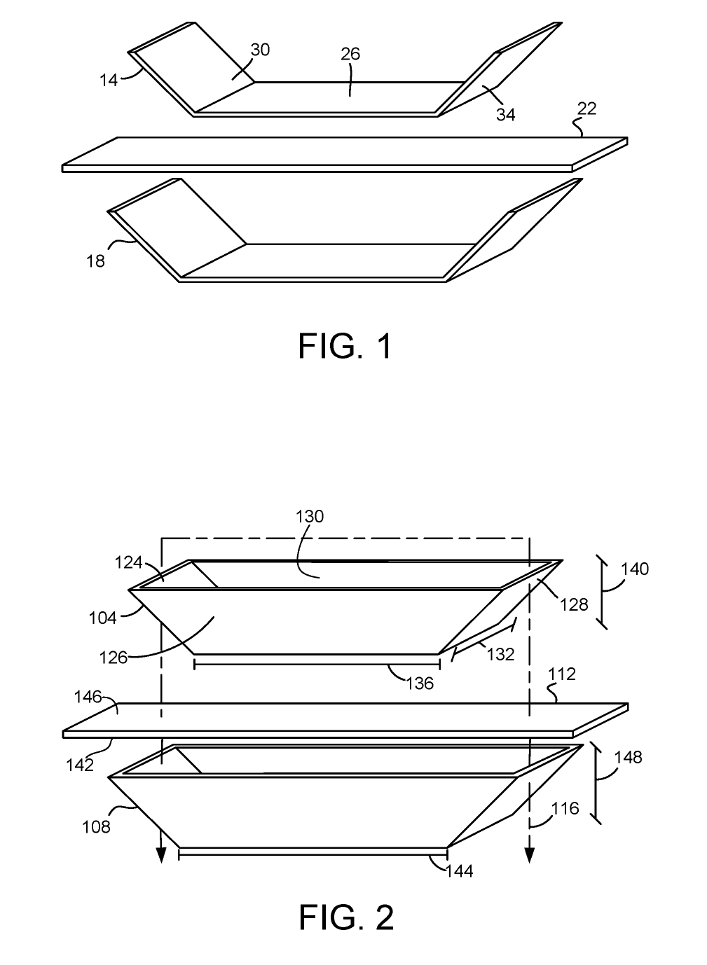

Accordingly, examples are disclosed that relate to composites and methods for forming non-planar composites that address one or more of the preceding issues. With reference now to FIG. 1, in some examples a non-planar composite may be formed using a first non-planar metallic skin 14, a second non-planar metallic skin 18 and a substantially planar core 22. In some examples the first non-planar metallic skin 14 and the second non-planar metallic skin 18 may be pre-formed from flat sheets into a non-planar shape.

In the example schematically illustrated in FIG. 1, the first non-planar metallic skin 14 and the second non-planar metallic skin 18 are generally U-shaped. In this example, each of the first non-planar metallic skin 14 and the second non-planar metallic skin 18 comprise a first face 26 along with a second face 30 and a third face 34 that may form angles with the first face 26 to form a U-shaped metallic skin. In this example, and as described in more detail below regarding other examples, the second non-planar metallic skin 18 has substantially the same shape as the first non-planar metallic skin 14.

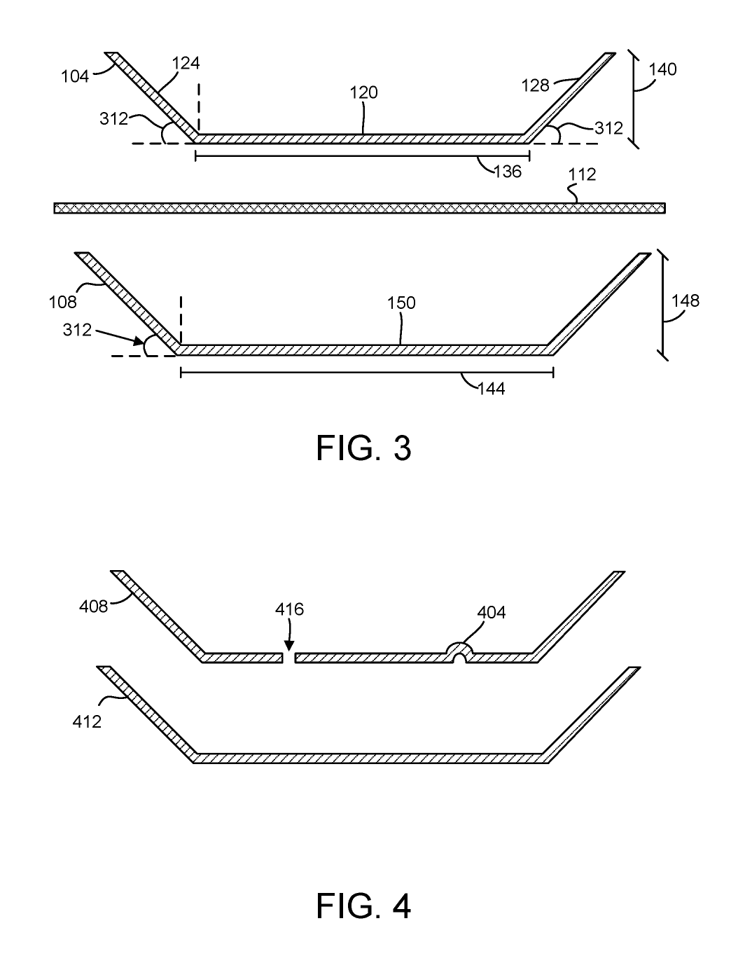

In another example schematically illustrated in FIGS. 2 and 3, a first non-planar metallic skin 104 and a second non-planar metallic skin 108 are generally bucket-shaped. That is, the metallic skin has a shape defining a four-sided open top enclosure. In the example illustrated in FIGS. 2 and 3, a first face 120 (“end face”) and a second face 124 (“bottom face”) of the first non-planar metallic skin 104 are formed such that the second face 124 forms an angle 312 with respect to a plane of the first face 120. In this example, a third face 128 (also an end face) forms the same angle with respect to the plane of the first face. As shown in FIG. 2, in some examples opposing fourth face 126 and fifth face 130 (“side faces”) of the first non-planar metallic skin 104 each may form the same angle with respect to the first face 120. In other examples, opposing fourth face 126 and fifth face 130 each may form a different angle with respect to the first face 120.

FIG. 3 schematically illustrates a cross-section view of the generally bucket-shaped first non-planar metallic skin 104, core 112, and second non-planar metallic skin 108 taken through line 116 of FIG. 2. As shown in this figure, the second face 124 of the first non-planar metallic skin 104 forms an angle 312 of approximately 45 degrees with the plane of the first face 120. In this example, the first non-planar metallic skin 104 is symmetrical, with the third face 128 opposite the second face 124 forming the same angle 312 with the respect to the plane of the first face 120, and with fourth face 126 and fifth face 130 forming the same angle with the respect to the plane of the first face 120.

In this example, the second non-planar metallic skin 108 has substantially the same shape as the first non-planar metallic skin 104. For example, in FIGS. 2 and 3, the first non-planar metallic skin 104 and the second non-planar metallic skin 108 have the same angles 312, and each end face of the two skins has the same width 132. Additionally, the skins may have minor differences to accommodate manufacturing considerations, such as using the skins with a punch and die to form non-planar composites as described in more detail below. In present example, the first face 120 of first non-planar metallic skin 104 may have a first length 136 and the first face 150 of the second non-planar metallic skin 108 may have a second length 144 that is greater than the first length 136 to be compatible with a core 112 having a desired thickness or volume. Similarly, the second non-planar metallic skin 108 may have a second height 148 that is greater than the first height 140 of the first non-planar metallic skin 104. Accordingly and in some examples, first and second non-planar metallic skins may have substantially the same shape where both skins have substantially the same dimensions, angles, curvatures and other geometric properties, with minor differences included for manufacturing purposes.

In the present example, as described in more detail below and with brief reference to FIG. 9, the first non-planar metallic skin 104, core 112, and second non-planar metallic skin 108 may be pressed into a uniform, non-planar composite 900 having an opposing second face 124 and third face 128 that are angled with respect to the first face 120. As noted above, planar laminated composites may lack sufficient structural integrity to enable the materials to be formed into non-planar shapes. In different examples, planar laminated composites are limited to bending by approximately 1-10 degrees, beyond which structural failures and other damage may occur making them unsuitable for their intended purpose.

Accordingly, and in one potential advantage of the present disclosure, in some examples the methods disclosed herein may form non-planar composites having adjacent faces that form angles of at least 15 degrees with one another. While the disclosed example describes a 45 degree angle between faces, composites having many different angles, curvatures, and a variety of different shapes also may be formed using the disclosed methods and techniques.

Additionally, it will be appreciated that this example and the other examples of non-planar shapes shown and described in this disclosure are provided for clarity of description and for illustrative purposes. In other examples, a wide variety of non-planar shapes, including but not limited to shapes with fewer or more angled surfaces, curved surfaces, and symmetrical and asymmetrical aspects, may be utilized for the non-planar metallic skins and to form composites of the present disclosure.

With reference again to FIGS. 2 and 3 and as noted above, the first non-planar metallic skin 104 and the second non-planar metallic skin 108 may be used to deform the substantially planar core 112 into the non-planar shape of the first and the second non-planar metallic skins. Additionally, the first non-planar metallic skin 104 and the second non-planar metallic skin 108 may be used to bond the core 112 to one or both of the skins to form a non-planar composite. In this manner, and in one potential advantage of the present disclosure, the resulting non-planar composite may comprise a lightweight, strong and stiff structure that may be formed by a lower cost and less-labor-intensive method than by using other materials and methods.

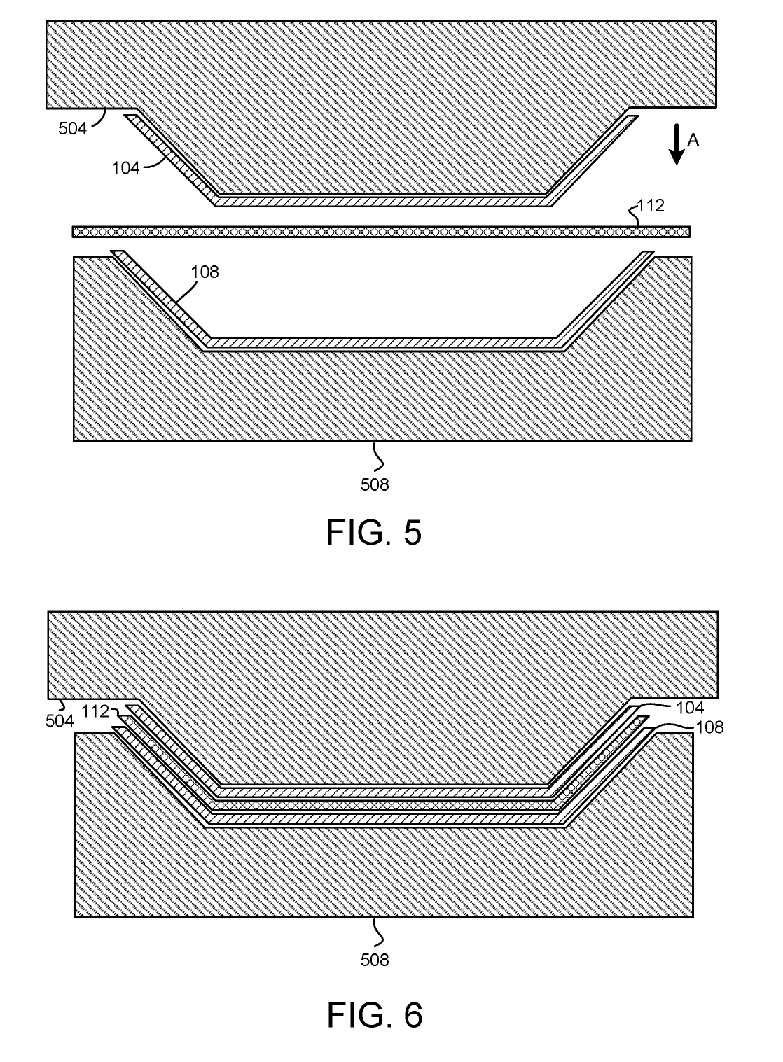

In other examples, one or more features may be pre-formed in the first non-planar metallic skin and/or the second non-planar metallic skin. In some examples, the one or more features may be pre-formed in either the first non-planar metallic skin or the second non-planar metallic skin. In one example illustrated schematically in FIG. 4, a structural rib 404 or a hollow boss may be formed in a first non-planar metallic skin 408. One or more other features may also be formed, such as a hole or an opening 416 or other features that may provide an interface through the materials.

In some examples, the first non-planar metallic skin 408 and a second non-planar metallic skin 412 may comprise machined parts. For example, the first non-planar metallic skin 408 and the second non-planar metallic skin 412 may be machined parts of an enclosure for a computing device.

In the examples described above, the first non-planar metallic skin and the second non-planar metallic skin may be pre-formed. Pre-forming the first non-planar metallic skin and the second non-planar metallic skin may be accomplished using standard stamping technology or any other suitable method. For example, sheet metal, which may comprise aluminum, stainless steel, copper or any other suitable metal, may be formed into a desired shape.

In some examples, the first non-planar metallic skin and the second non-planar metallic skin may comprise different materials. For example, where one of the skins is intended to face an interior portion of an enclosure for a computing device, such skin may be formed from copper to encourage heat conduction away from components of the computing device. In this example, the other skin may be intended to function as the outside of the enclosure. Accordingly, this skin may be machined from stainless steel to provide the structure with durability. In another example, an exterior-facing metallic skin may be stainless steel while the other skin intended to face the inside of the structure may be formed from a lighter-weight aluminum and/or magnesium alloy.

In a similar manner, a variety of materials may be utilized for the core 112. For example, the core 112 may comprise a polymer material, such as polyethylene, acrylonitrile butadiene styrene (ABS), polycarbonate, polypropylene, polysulfone or any other suitable material. In some examples the core may comprise a polymer film. In other examples, the core 112 may comprise a material such as an insulator or dielectric to provide the composite with desirable electrical properties. In some examples, the core 112 may have sufficient structural integrity without additional reinforcements, such as impregnated metal fibers.

In various examples, different thicknesses for the core 112 may be utilized. In some examples, a thickness for the core 112 may be selected based on one or more other parameters of the laminate composite and/or the intended use of the composite. In some examples, a core thickness of approximately 0.5 mm may be utilized. In some examples, utilizing a core thickness less than approximately 0.5 mm may negate the weight savings as compared to a solid structure of the same shape and materials. In other examples, such as forming a composite for an aircraft wing, significantly thicker cores may be utilized. In these examples, composites of the present disclosure may be formed having core thicknesses as great as approximately 0.5 m.

In another example, the first non-planar metallic skin and the second non-planar metallic skin may be formed from aluminum having a 0.1 mm thickness, and the core may comprise a polymer having a uniform 0.4 mm thickness. In this example, the thickness of the two layers of metallic skin and the core result in a composite having a 0.6 mm thickness. The 0.6 mm thick composite may be nearly as stiff and as strong as a 0.6 mm thick solid aluminum plate. Additionally, an approximately 40% weight reduction may be attained by utilizing the polymer core.

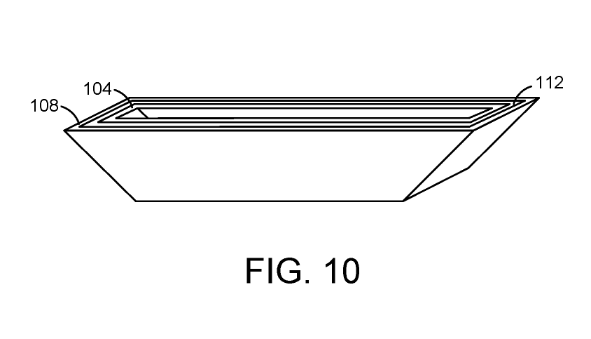

With reference now to FIG. 5, a punch 504 and a die 508 that may be used to form a non-planar composite according to examples of the present disclosure are schematically illustrated. In the example of FIG. 5, first non-planar metallic skin 104 is inserted over the punch 504, and second non-planar metallic skin 108 is inserted in the die 508. The core 112 is placed between the punch 504 and the die 508. In some examples, one or more of the first non-planar metallic skin 104 and the second non-planar metallic skin 108 may be held in place via a vacuum. With the skins and core in place, and with reference also to FIG. 6, the punch 504 is then translated downwardly in the direction of arrow A to compressively deform the core between the skins. In this manner, the first non-planar metallic skin 104 and the second non-planar metallic skin 108 are used to deform the core 112 between the skins to form the four-sided open top enclosure illustrated in FIG. 10.

Deforming the core 112 may additionally include thermoforming the core. In some examples, when using the first non-planar metallic skin 104 and the second non-planar metallic skin 108 to thermoform the core 112, the punch 504 may comprise a heated punch, the die 508 may comprise a heated die, and the core 112 may comprise a thermoplastic polymer. In other examples, thermoforming the core 112 may comprise heating the core prior to deforming the core between the first non-planar metallic skin 104 and the second non-planar metallic skin 108. In yet other examples, the core 112 may be preheated, and then deformed using the first non-planar metallic skin 104 and the second non-planar metallic skin 108 with a non-heated punch and die.

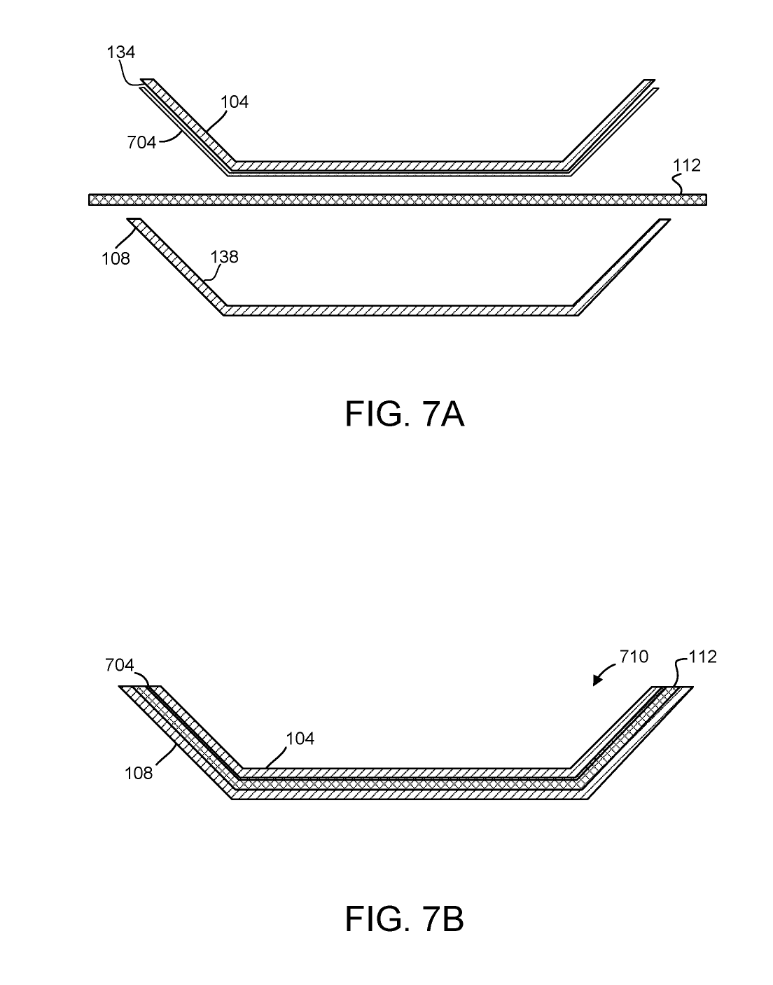

In addition to deforming the core 112, the first non-planar metallic skin 104 and the second non-planar metallic skin 108 are used to bond the core to one or more of the skins, as described above. In some examples, an adhesive may be applied to one or more of the first non-planar metallic skin and the second non-planar metallic skin. As schematically illustrated in FIG. 7A, in one example an adhesive 704 may be applied to an underside 134 of the first non-planar metallic skin 104 prior to using the first non-planar metallic skin and the second non-planar metallic skin 108 to deform the core. In this manner and upon compressive forming as described above, the core 112 may be bonded to at least the first skin 104. In other examples, the adhesive 704 may be applied to the top side 138 of the second non-planar metallic skin 108 prior to using the first non-planar metallic skin and the second non-planar metallic skin to deform the core. An example of a composite 710 formed using an adhesive as described above is shown in FIG. 7B.

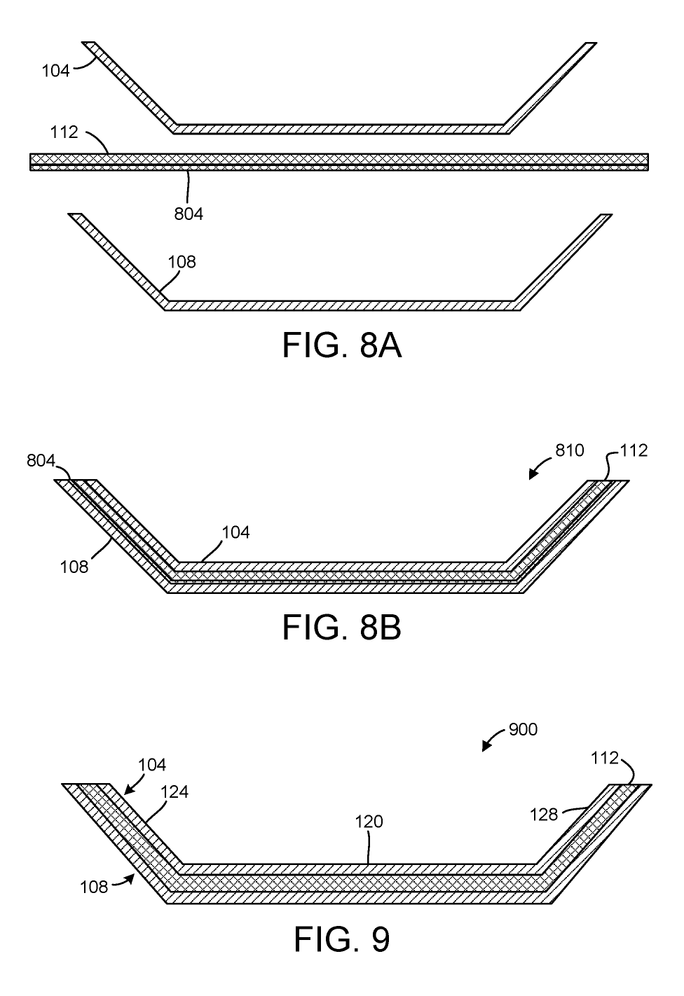

FIG. 8A illustrates an example of an adhesive 804 applied to an underside 142 of the core 112 before using first non-planar metallic skin 104 and second non-planar metallic skin 108 to deform and bond the core 112. In this manner and upon compressive forming as described above, the core 112 may be bonded to at least the second skin 108. In other examples, the adhesive 804 may be applied to the top side 146 of the core 112 before using the first non-planar metallic skin and the second non-planar metallic skin to deform the core. An example of a composite 810 formed using an adhesive as described above is shown in FIG. 8B.

In the above examples, the adhesives 704 and 804 may comprise an adhesive film, a primer, or a spray glue applied before the forming process to bond the core 112 to one or more of the metal skins. For example, the adhesive may comprise a film that is preapplied to one or both sides of the core 112, or provided as a separate sheet or film and formed onto the core 112. In various examples the adhesive may comprise an acrylic, silicone or urethane material, or any other suitable material to bond the core 112 to one or more of the metal skins.

In some examples, the core 112 may comprise an adhesive material or embody adhesive properties. For example, the core 112 may comprise a thermosetting polymer. In these examples, the core may bond well to one or more of the metal skins in the forming operation.

In the examples described above, setting or bonding the core 112 to one or more of the first non-planar metallic skin 104 and the second non-planar metallic skin 108 may be combined with deforming the core between the skins in a single compressive forming operation, press or step. Carrying out these processes in a single step may minimize the space and capital investment demands of production machinery, while also improving standardization and consistency in forming and bonding the composite.

Once the forming and bonding steps are complete, the composite may be blanked out and subjected to additional trimming or cleaning steps to form a final product. For example, FIG. 9 schematically illustrates a cross-section view of a non-planar composite 900 formed according to one or more of the above-described methods. The composite 900 comprises a first non-planar metallic skin 104, a second non-planar metallic skin 108 and a thermosetting polymeric core 112 between the two skins.

FIG. 10 schematically illustrates a perspective view of a non-planar composite 1000 formed from the first non-planar metallic skin 104, second non-planar metallic skin 108, and core 112 of FIG. 2 according to one of the above-described methods.

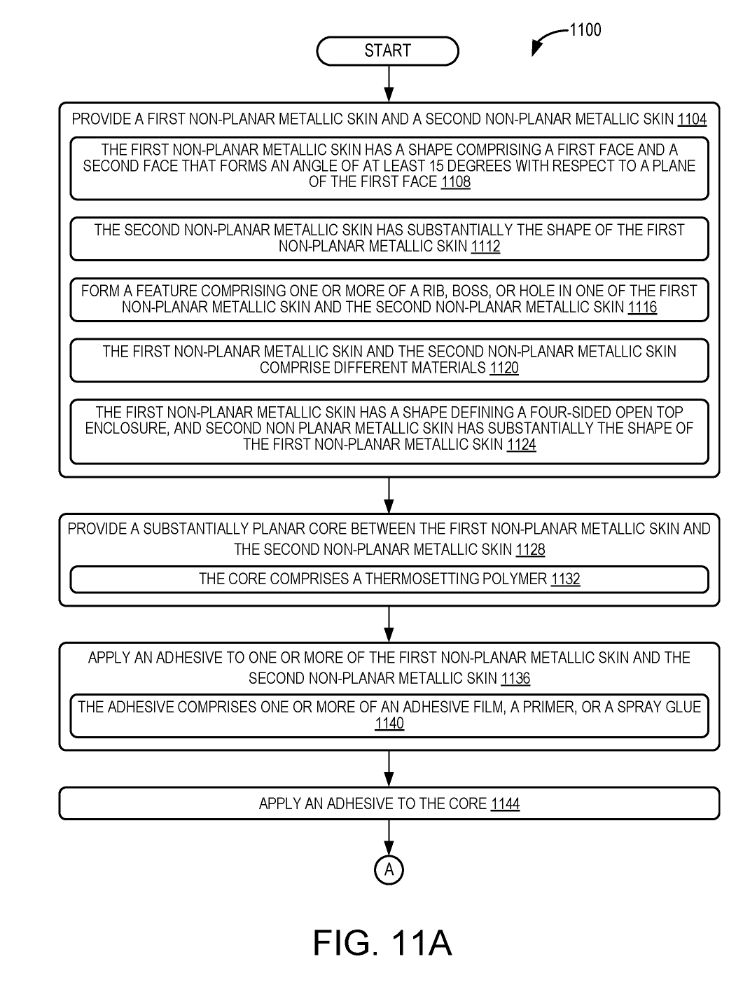

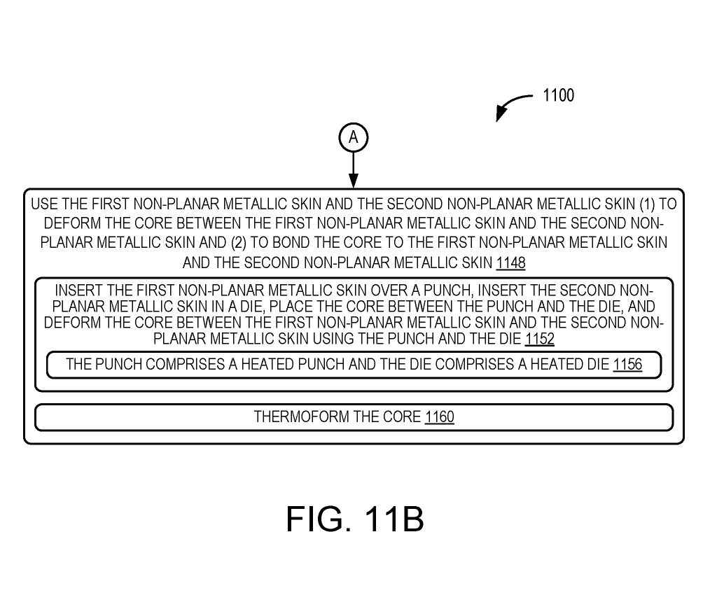

FIGS. 11A and 11B illustrate a flow chart of a method 1100 for forming a non-planar composite according to examples of the present disclosure. The following description of method 1100 is provided with reference to the materials and processes described above and shown in FIGS. 1-10. It will be appreciated that method 1100 also may be performed in other contexts using other suitable materials or processes.

With reference to FIG. 11A, at 1104, the method 1100 may include providing a first non-planar metallic skin and a second non-planar metallic skin. At 1108, the method 1100 may include wherein the first non-planar metallic skin has a shape comprising a first face and a second face that forms an angle of at least 15 degrees with respect to a plane of the first face. At 1112, the method 1100 may include the second non-planar metallic skin has substantially the shape of the first non-planar metallic skin.

At 1116, the method 1100 may include forming a feature comprising one or more of a rib, boss, and hole in the first non-planar metallic skin or the second non-planar metallic skin. At 1120, the method 1100 may include wherein the first non-planar metallic skin and the second non-planar metallic skin comprise different materials. At 1124, the method 1100 may include wherein the first non-planar metallic skin has a shape defining a four-sided open top enclosure, and the second non-planar metallic skin has substantially the shape of the first non-planar metallic skin.

At 1128, the method 1100 may include providing a substantially planar core between the first non-planar metallic skin and the second non-planar metallic skin. At 1132, the method 1100 may include wherein the core comprises a thermosetting polymer.

At 1136, the method 1100 may include applying an adhesive to one or more of the first non-planar metallic skin and the second non-planar metallic skin prior to using the first non-planar metallic skin and the second non-planar metallic skin to deform and bond the core. At 1140, the method 1100 may include wherein the adhesive is an adhesive film, a primer, or a spray glue. At 1144, the method 1100 may include applying an adhesive to the core before using the first non-planar metallic skin and the second non-planar metallic skin to deform and bond the core.

With reference to FIG. 11B, At 1148, the method 1100 may include using the first non-planar metallic skin and the second non-planar metallic skin (1) to deform the core between the first non-planar metallic skin and the second non-planar metallic skin and (2) to bond the core to one or more of the first non-planar metallic skin and the second non-planar metallic skin.

At 1152, the method 1100 may include wherein using the first non-planar metallic skin and the second non-planar metallic skin to deform the core comprises inserting the first non-planar metallic skin over a punch, inserting the second non-planar metallic skin in a die, placing the core between the punch and the die, and deforming the core between the first non-planar metallic skin and the second non-planar metallic skin using the punch and the die. At 1156, the method 1100 may include wherein the punch comprises a heated punch and the die comprises a heated die. At 1160, the method 1100 may include wherein using the first non-planar metallic skin and the second non-planar metallic skin to deform the core comprises thermoforming the core.

The following paragraphs provide additional support for the claims of the subject application. One aspect provides a method for forming a non-planar composite, comprising: providing a first non-planar metallic skin and a second non-planar metallic skin, providing a substantially planar core between the first non-planar metallic skin and the second non-planar metallic skin, and using the first non-planar metallic skin and the second non-planar metallic skin (1) to deform the core between the first non-planar metallic skin and the second non-planar metallic skin and (2) to bond the core to one or more of the first non-planar metallic skin and the second non-planar metallic skin.

The method may additionally or alternatively include, wherein the first non-planar metallic skin has a shape comprising a first face and a second face that forms an angle of at least 15 degrees with respect to a plane of the first face, and the second non-planar metallic skin has substantially the shape of the first non-planar metallic skin. The method may additionally or alternatively include forming a feature comprising one or more of a rib, boss, and hole in the first non-planar metallic skin or the second non-planar metallic skin. The method may additionally or alternatively include, wherein the first non-planar metallic skin and the second non-planar metallic skin comprise different materials.

The method may additionally or alternatively include, wherein the first non-planar metallic skin has a shape defining a four-sided open top enclosure, and the second non-planar metallic skin has substantially the shape of the first non-planar metallic skin. The method may additionally or alternatively include, wherein using the first non-planar metallic skin and the second non-planar metallic skin to deform the core comprises inserting the first non-planar metallic skin over a punch, inserting the second non-planar metallic skin in a die, placing the core between the punch and the die, and compressively deforming the core between the first non-planar metallic skin and the second non-planar metallic skin using the punch and the die. The method may additionally or alternatively include, wherein the punch comprises a heated punch and the die comprises a heated die. The method may additionally or alternatively include, wherein using the first non-planar metallic skin and the second non-planar metallic skin to deform the core comprises thermoforming the core.

The method may additionally or alternatively include applying an adhesive to one or more of the first non-planar metallic skin and the second non-planar metallic skin prior to using the first non-planar metallic skin and the second non-planar metallic skin to deform and bond the core. The method may additionally or alternatively include applying an adhesive to the core before using the first non-planar metallic skin and the second non-planar metallic skin to deform and bond the core. The method may additionally or alternatively include, wherein the adhesive is an adhesive film, a primer, or a spray glue. The method may additionally or alternatively include, wherein the core comprises a thermosetting polymer.

Another aspect provides a composite, comprising: a first non-planar metallic skin, a second non-planar metallic skin, and a polymeric core between the first non-planar metallic skin and the second non-planar metallic skin, wherein the polymeric core is deformed from a planar configuration via compressive forming by the first non-planar metallic skin and the second non-planar metallic skin.

The composite may additionally or alternatively include, wherein the polymeric core is bonded to one or more of the first non-planar metallic skin and the second non-planar metallic skin via the compressive forming. The composite may additionally or alternatively include, wherein the polymeric core is deformed via compressive forming using a heated punch and a heated die.

The composite may additionally or alternatively include, wherein the first non-planar metallic skin has a shape comprising a first face and a second face that forms an angle of at least 15 degrees with respect to a plane of the first face, and the second non-planar metallic skin has substantially the shape of the first non-planar metallic skin. The composite may additionally or alternatively include, wherein the first non-planar metallic skin has a shape defining a four-sided open top enclosure, and the second non-planar metallic skin has substantially the shape of the first non-planar metallic skin.

The composite may additionally or alternatively include, wherein the first non-planar metallic skin and the second non-planar metallic skin comprise different materials. The composite may additionally or alternatively include an adhesive applied to one or more of the first non-planar metallic skin, the second non-planar metallic skin, and the core prior to the compressive forming.

Another aspect provides a method for forming a non-planar composite, comprising: providing a first non-planar metallic skin and a second non-planar metallic skin, providing a substantially planar thermosetting polymer core between the first non-planar metallic skin and the second non-planar metallic skin, and using the first non-planar metallic skin and the second non-planar metallic skin (1) to thermoform the core between the first non-planar metallic skin and the second non-planar metallic skin and (2) to bond the core to one or more of the first non-planar metallic skin and the second non-planar metallic skin.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for forming a non-planar composite, comprising:
providing a first non-planar metallic skin and a second non-planar metallic skin;
providing a substantially planar core between the first non-planar metallic skin and the second non-planar metallic skin; and
using the first non-planar metallic skin and the second non-planar metallic skin (1) to deform the core between the first non-planar metallic skin and the second non-planar metallic skin and (2) to bond the core to one or more of the first non-planar metallic skin and the second non-planar metallic skin.

2. The method of claim 1, wherein the first non-planar metallic skin has a shape comprising a first face and a second face that forms an angle of at least 15 degrees with respect to a plane of the first face, and the second non-planar metallic skin has substantially the shape of the first non-planar metallic skin.

3. The method of claim 1, further comprising forming a feature comprising one or more of a rib, boss, and hole in the first non-planar metallic skin or the second non-planar metallic skin.

4. The method of claim 1, wherein the first non-planar metallic skin and the second non-planar metallic skin comprise different materials.

5. The method of claim 1, wherein the first non-planar metallic skin has a shape defining a four-sided open top enclosure, and the second non-planar metallic skin has substantially the shape of the first non-planar metallic skin.

6. The method of claim 1, wherein using the first non-planar metallic skin and the second non-planar metallic skin to deform the core comprises:
inserting the first non-planar metallic skin over a punch;
inserting the second non-planar metallic skin in a die;
placing the core between the punch and the die; and
compressively deforming the core between the first non-planar metallic skin and the second non-planar metallic skin using the punch and the die.

7. The method of claim 6, wherein the punch comprises a heated punch and the die comprises a heated die.

8. The method of claim 1, wherein using the first non-planar metallic skin and the second non-planar metallic skin to deform the core comprises thermoforming the core.

9. The method of claim 1, further comprising applying an adhesive to one or more of the first non-planar metallic skin and the second non-planar metallic skin prior to using the first non-planar metallic skin and the second non-planar metallic skin to deform and bond the core.

10. The method of claim 1, further comprising applying an adhesive to the core before using the first non-planar metallic skin and the second non-planar metallic skin to deform and bond the core.

11. The method of claim 10, wherein the adhesive is an adhesive film, a primer, or a spray glue.

12. The method of claim 1, wherein the core comprises a thermosetting polymer.

13. A composite, comprising:
a first non-planar metallic skin;
a second non-planar metallic skin; and
a polymeric core between the first non-planar metallic skin and the second non-planar metallic skin, wherein the polymeric core is deformed from a planar configuration via compressive forming by the first non-planar metallic skin and the second non-planar metallic skin.

14. The composite of claim 13, wherein the polymeric core is bonded to one or more of the first non-planar metallic skin and the second non-planar metallic skin via the compressive forming.

15. The composite of claim 13, wherein the polymeric core is deformed via compressive forming using a heated punch and a heated die.

16. The composite of claim 13, wherein the first non-planar metallic skin has a shape comprising a first face and a second face that forms an angle of at least 15 degrees with respect to a plane of the first face, and the second non-planar metallic skin has substantially the shape of the first non-planar metallic skin.

17. The composite of claim 13, wherein the first non-planar metallic skin has a shape defining a four-sided open top enclosure, and the second non-planar metallic skin has substantially the shape of the first non-planar metallic skin.

18. The composite of claim 13, wherein the first non-planar metallic skin and the second non-planar metallic skin comprise different materials.

19. The composite of claim 13, further comprising an adhesive applied to one or more of the first non-planar metallic skin, the second non-planar metallic skin, and the core prior to the compressive forming.

20. A method for forming a non-planar composite, comprising:
providing a first non-planar metallic skin and a second non-planar metallic skin;
providing a substantially planar thermosetting polymer core between the first non-planar metallic skin and the second non-planar metallic skin; and
using the first non-planar metallic skin and the second non-planar metallic skin (1) to thermoform the core between the first non-planar metallic skin and the second non-planar metallic skin and (2) to bond the core to one or more of the first non-planar metallic skin and the second non-planar metallic skin.
